(19) United States
(12) Patent Application Publication
(10) Pub. No.: US 2026/0329093 A1
(43) Pub. Date: Oct. 22, 2026

(54) OPTICAL ELEMENT AND DISPLAYING APPARATUS INCLUDING THE SAME

(71) Applicant: CANON KABUSHIKI KAISHA, Tokyo (JP)

(72) Inventors: KANETO TSUNEMITSU, Kanagawa (JP); KOUICHI YONETANI, Kanagawa (JP); KUMIKO YASHIMA, Tokyo (JP)

(21) Appl. No.: 19/650,168

(22) Filed: Apr. 16, 2026

(30) Foreign Application Priority Data
Apr. 22, 2025 (JP) 2025-070150

(51) Int. Cl. G02B 27/01

(52) U.S. Cl. CPC G02B 27/0172; G02B 2027/0132

(57) ABSTRACT

An optical element according to the disclosure includes a substrate having an optical surface including a predetermined region in a curved surface shape, and a film provided on the predetermined region. A rough surface portion having a first surface roughness, and a mirror surface portion having a second surface roughness smaller than the first surface roughness are provided in an outer peripheral region in the predetermined region.

### BACKGROUND

### Field of the Technology

The aspect of the embodiments is related to an optical element and a displaying apparatus including the optical element.

### Description of the Related Art

Conventionally, an optical element provided with a predetermined optical performance by attaching a film onto a substrate has been used.

Japanese Patent Laid-Open No. 2005-37534 discloses a filter for a displaying apparatus in which adhesion failure of a film to a substrate is suppressed by controlling surface roughness on the substrate to which the film is attached to improve adhesion strength of the film.

On the other hand, there is a case where an image of an eyeball of a user is picked-up in order to detect a line of sight of the user in a displaying apparatus such as a head-mounted display.

Therefore, when an optical element in which a film is attached to a substrate whose surface roughness is controlled based on Japanese Patent Laid-Open No. 2005-37534 is used in such displaying apparatus, light from the eyeball of the user may be diffused when passing through the optical element to suppress the detection of the line of sight of the user.

### SUMMARY

An optical element according to the disclosure includes a substrate having an optical surface including a predetermined region in a curved surface shape, and a film provided on the predetermined region. A rough surface portion having a first surface roughness, and a mirror surface portion having a second surface roughness smaller than the first surface roughness are provided in an outer peripheral region in the predetermined region.

Features of the disclosure will become apparent from the following description of embodiments with reference to the attached drawings. The following description of embodiments is described by way of example.

### BRIEF DESCRIPTION OF THE DRAWINGS

FIG. 1A is a front view of an optical element according to an embodiment of the disclosure.

FIG. 1B is a cross sectional view of the optical element according to the embodiment.

FIG. 2A is a cross sectional view for explaining a step in a method for manufacturing the optical element according to the embodiment.

FIG. 2B is a cross sectional view for explaining a step in the method for manufacturing the optical element according to the embodiment.

FIG. 2C is a cross sectional view for explaining a step in the method for manufacturing the optical element according to the embodiment.

FIG. 2D is a cross sectional view for explaining a step in the method for manufacturing the optical element according to the embodiment.

FIG. 2E is a cross sectional view for explaining a step in the method for manufacturing the optical element according to the embodiment.

FIG. 3A is a front view of an optical element according to an embodiment of the disclosure.

FIG. 3B is a front view and a cross sectional view of an optical element according to an embodiment of the disclosure.

FIG. 3C is a front view of an optical element according to an embodiment of the disclosure.

FIG. 4A is a side view of an HMD including an optical element according to an embodiment of the disclosure.

FIG. 4B is a front view of the HMD including the optical element according to the embodiment of the disclosure.

FIG. 4C is a partial cross sectional view of the HMD including the optical element according to the embodiment of the disclosure.

FIG. 4D is a partial cross sectional view of the HMD including the optical element according to the embodiment of the disclosure.

FIG. 5A is a front view of an optical element according to an embodiment of the disclosure.

FIG. 5B is a front view of an optical element according to an embodiment of the disclosure.

FIG. 5C is a front view of an optical element according to a comparative example.

### DESCRIPTION OF THE EMBODIMENTS

Hereinafter, an optical element according to the disclosure is described in detail with reference to the accompanying drawings. Note that the drawings described below may be drawn on a scale different from the actual scale in order to facilitate understanding of the disclosure.

In recent years, a head-mounted display (HMD) has been used in various fields such as virtual reality (VR), augmented reality (AR), and mixed reality (MR).

Specifically, the HMD is provided with an optical system for forming an image displayed on a display at a position of an eye of the user.

In addition, in the optical system provided in the HMD, reductions in size and weight and an improvement in image quality are achieved by folding an optical path of image light using a polarization state of the image light and a half mirror.

In particular, it is known that further reductions in size and weight can be achieved by using an optical element in which a film having an optical characteristic, such as a polarization film, a polarized beam splitter (PBS) film, or a phase difference film, is attached onto a substrate having a curved surface shape.

Therefore, a polarization optical element in which the polarization film is attached onto the substrate having the curved surface shape has been proposed.

On the other hand, in an optical element in which a uniaxially stretched film such as the polarization film is attached onto the substrate having the curved surface shape, there is a concern that an adhesion failure portion (lift) of the film may occur in a peripheral portion when the optical element is exposed to a high temperature, a low temperature or the like, or when an impact is applied to the optical element.

This is because, a degree of elasticity of a film is different between a stretching direction and a non-stretching direction of the film due to a retention of internal stress during a manufacturing process in the film manufactured by uniaxial stretching, such as the polarization film.

For example, a reflecting polarization film has such a feature that it is easily stretched in a transmission axis direction, which is the non-stretching direction, whereas it is hardly stretched in a reflection axis direction, which is the stretching direction.

Therefore, lifting is likely to occur particularly in a peripheral portion in the reflection axis direction, in a reflecting polarization optical element in which the reflecting polarization film is attached onto a substrate having a curved surface shape.

That is, when the reflecting polarization optical element is placed in a high temperature environment, adhesion failure of the reflecting polarization film may occur in the peripheral portion, particularly in the peripheral portion in the reflection axis direction.

In addition, a transparent substrate for a displaying apparatus in which a surface roughness of a surface is adjusted in order to improve an adhesion strength of a film attached onto the surface has been proposed.

It is expected that it is possible to suppress an occurrence of lifting of a reflecting polarization film attached onto a substrate by adjusting the surface roughness over the entire peripheral portion on the substrate having a curved surface shape according to the above-mentioned technique.

However, in one embodiment, it is necessary to consider guiding of light for line-of-sight detection for picking-up an image of an illuminated eyeball of a user when an optical element in which the reflecting polarization film is attached onto the substrate having the curved surface shape is used in an HMD.

In other words, the optical element used in the HMD has a function of guiding light for line-of-sight detection for picking-up the image of the illuminated eyeball of the user in addition to that of forming an image displayed on a display on an eye of the user.

Therefore, in one embodiment, it is necessary to provide a transparent region for guiding light for line-of-sight detection in addition to a region for guiding image light emitted from the display in the optical element used in the HMD.

On the other hand, it is difficult to provide such transparent region for guiding the light for line-of-sight detection when the surface roughness of the reflecting polarization film attached to the entire peripheral portion of the substrate of the optical element is adjusted in accordance with the above-described technique so as to suppress the occurrence of the lifting thereof.

In other words, it is difficult to achieve both of the suppression of the occurrence of the lifting of the attached reflecting polarization film and the guiding of light for line-of-sight detection when the optical element formed in accordance with the above-described technique is used in the HMD.

Accordingly, an object of the disclosure is to provide an optical element capable of achieving both of the suppression of the occurrence of the lifting of the reflecting polarization film and the guiding of light for line-of-sight detection.

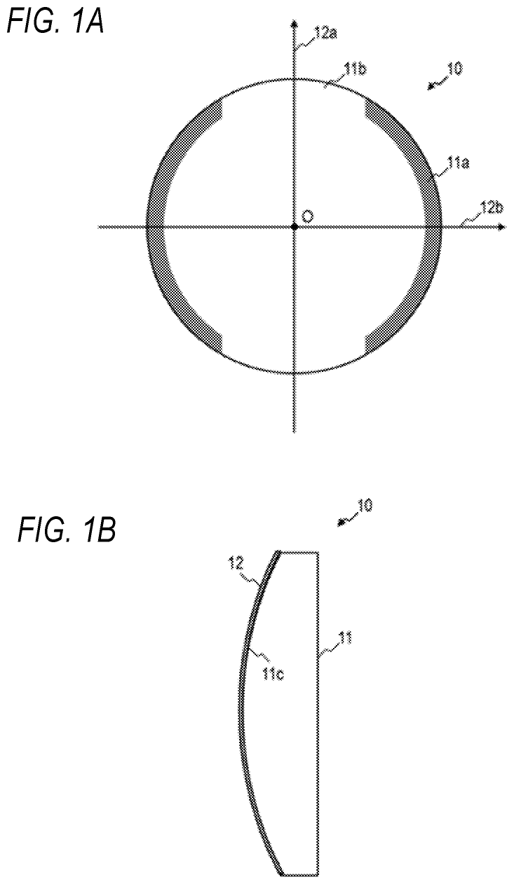

FIGS. 1A and 1B show a schematic front view and a schematic cross sectional view of an optical element 10 according to an embodiment of the disclosure, respectively.

As shown in FIGS. 1A and 1B, a reflecting polarization film 12 is laminated (attached) on one optical surface (hereinafter referred to as a curved surface portion 11c) having a curved surface shape of a substrate 11 in the optical element 10 according to the embodiment.

Specifically, the reflecting polarization film 12 is formed by alternately stacking several hundred layers of a first sheet and a second sheet made of different materials.

A reflecting polarization function is generated by stretching the reflecting polarization film 12 in a predetermined direction since birefringences generated in the first and second sheets due to the stretching are different from each other.

That is, light having polarization parallel to the stretching direction (hereinafter referred to as a reflection axis) with respect to the reflecting polarization film 12 is not transmitted but reflected, whereas light having polarization perpendicular to the stretching direction (hereinafter, referred to as a transmission axis) can be transmitted.

The reflecting polarization film 12 has a low elastic modulus in the transmission axis but a high elastic modulus in the reflection axis in accordance with the above-described characteristics.

The substrate 11 has a convex lens shape or a concave lens shape, and a curvature radius and a diameter of the curved surface portion 11c (the curvature radius and the diameter of a spherical surface optimally determined by a least-squares method in the case of an aspherical surface) are represented by R and L, respectively.

The diameter L of the curved surface portion 11c is a diameter of a circle formed when the curved surface portion 11c is projected onto a plane perpendicular to the optical axis.

At this time, a half opening angle θ is defined by the following Expression (1):

$$sin θ = \frac{( \frac{L}{2} )}{R} . \qquad ( 1 )$$

The half opening angle θ is appropriately set according to a design or the like of the substrate 11 that functions as a lens, and effects of the disclosure described below do not depend on the half opening angle θ.

The substrate 11 can be formed by a transparent plastic material or glass material having transparency to light such as visible light.

Specifically, in one embodiment, the substrate 11 can be formed by injection molding and is formed by a plastic material that is optically used.

More specifically, the substrate 11 can be formed by a plastic material such as polycarbonate (PC), polyester (PEs), polymethyl methacrylate (PMMA), cycloolefin polymer (COP), or cycloolefin copolymer (COC).

Further, the substrate 11 can be formed by a glass material such as synthetic quartz or BK-7 which is a general glass material.

Next, a method for laminating the reflecting polarization film 12 on the curved surface portion 11c of the substrate 11 to form the optical element 10 according to the embodiment is described.

For example, vacuum molding, pressure molding, or insert molding in which a lens base material is injection-molded on a reflecting polarization film can be used in order to obtain a reflecting polarization optical element by laminating a reflecting polarization film on an optical surface having a curved surface shape of a substrate.

On the other hand, in one embodiment, it is necessary to stretch the reflecting polarization film in order to attach the reflecting polarization film having a planar shape onto the optical surface having the curved surface shape of the substrate by using the above-described method.

In this case, the reflecting polarization film is stretched to a greater extent toward an outer peripheral portion of the optical surface having the curved surface shape or as the half opening angle θ of the optical surface having the curved surface shape increases.

Therefore, an internal stress accumulated in the reflecting polarization film is increased in the outer peripheral portion of the formed reflecting polarization optical element.

When heat, an impact or the like is applied to such reflecting polarization optical element from an external environment, the reflecting polarization film in which the large internal stress is accumulated in the outer peripheral portion may lift.

On the other hand, the elastic modulus in the reflection axis is higher than that in the transmission axis in the reflecting polarization film, as described above.

Therefore, the internal stress accumulated by stretching of the reflecting polarization film tends to be relatively larger in the reflection axis than in the transmission axis.

Thus, the reflecting polarization film is lifted, and the reflecting polarization film is easily peeled due to the lifting in a high-temperature environment, particularly in the outer peripheral portion in the reflection axis of the formed reflecting polarization optical element.

As described above, the inventors of the application have found that the lifting of the reflecting polarization film 12 is likely to occur, particularly in the outer peripheral portion in the reflection axis due to stretching of the reflecting polarization film 12 in the optical element 10 according to the embodiment.

Therefore, the occurrence of the lifting of the reflecting polarization film 12 in the outer peripheral portion in the reflection axis is suppressed by using the following structure in the optical element 10 according to the embodiment.

Referring back to FIGS. 1A and 1B, a rough surface portion 11a and a mirror surface portion 11b (first region) are provided in the outer peripheral region on the curved surface portion 11c of the substrate 11 to which the reflecting polarization film 12 is attached in the optical element 10 according to the embodiment.

Here, the outer peripheral region is a region within a range of 0.9×D to 1.0×D from the center O of a circle having a radius D (=L/2) when the curved surface portion 11c is projected onto a plane (first plane) perpendicular to the optical axis.

Further, the mirror surface portion 11b is a region through which most of main light incident on the substrate 11 can be transmitted, which is appropriately set according to the design or the like.

On the other hand, the rough surface portion 11a is a region processed to have a higher surface roughness than the mirror surface portion 11b.

That is, the rough surface portion 11a has a relatively large surface roughness (first surface roughness), whereas the mirror surface portion 11b has a relatively small surface roughness (second surface roughness).

Note that the rough surface portion 11a does not need to be formed by processing a predetermined region of the curved surface portion 11c, the entire surface of which is a mirror surface, into a rough surface, and may be formed together with the mirror surface portion 11b when the substrate 11 is formed by injection molding a plastic material, for example.

As described above, in the optical element 10 according to the embodiment, the adhesion strength of the reflecting polarization film 12 is increased in the rough surface portion 11a having a larger surface roughness than the mirror surface portion 11b of the substrate 11, thereby the occurrence of lifting or peeling of the reflecting polarization film 12 from the curved surface portion 11c can be suppressed.

In order to further suppress the occurrence of lifting or peeling of the reflecting polarization film 12 from the curved surface portion 11c, in one embodiment, the rough surface portion 11a has a rougher surface than the mirror surface portion 11b and has an arithmetic average roughness Ra equal to or larger than 20 nm.

Specifically, the arithmetic average roughness Ra of an optical surface of a lens generally used is about 10 nm, and an optical surface having the same degree of surface roughness is not sufficiently formed with a concave-convex shape having an anchor effect or the like for suppressing the occurrence of lifting or peeling of the reflecting polarization film 12.

On the other hand, it has been confirmed that an adhesion between an optical surface and an adhesive layer or the like provided on the reflecting polarization film 12 is enhanced to suppress the occurrence of lifting or peeling of the reflecting polarization film 12 in the optical surface having the arithmetic average roughness Ra of 20 nm or more, for example.

Further, the mirror surface portion 11b is provided in a region on the transmission axis side of the curved surface portion 11c in the optical element 10 according to the embodiment.

Thereby, the optical element 10 according to the embodiment can function as an optical element incorporated in a displaying apparatus such as an HMD including a line-of-sight detection device with effectively suppressing the occurrence of lifting or peeling of the reflecting polarization film 12.

The region on the transmission axis side (fourth region) means a region through which straight lines each of which forms an angle between −45° and 45° with respect to a straight line 12a (second straight line) passing through the center O of the curved surface portion 11c and parallel to the transmission axis pass in the outer peripheral region when the curved surface portion 11c is projected onto a plane perpendicular to the optical axis.

On the other hand, a region through which straight lines each of which forms an angle between −45° and 45° with respect to a straight line 12b (first straight line) passing through the center O of the curved surface portion 11c and parallel to the reflection axis pass in the outer peripheral region when the curved surface portion 11c is projected onto the plane perpendicular to the optical axis is referred to as a region on the reflection axis side (third region).

That is, it is possible to provide a transparent region as an optical path in the line-of-sight detection device by providing the mirror surface portion 11b in the region on the transmission axis side in the optical element 10 according to the embodiment.

In other words, the mirror surface portion 11b is provided so as to be closer to the straight line 12a than the straight line 12b in the outer peripheral region in the optical element 10 according to the embodiment.

On the other hand, it is possible to suppress the occurrence of lifting or peeling of the reflecting polarization film 12 in a region where the adhesion failure of the reflecting polarization film 12 is particularly likely to occur by providing the rough surface portion 11a in the region on the reflection axis side in the outer peripheral region.

In the optical element 10 according to the embodiment, an area (first area) of the rough surface portion 11a in the region on the reflection axis side is to be larger than the area (second area) of the rough surface portion 11a in the region on the transmission axis side in order to achieve both of the above-described two effects.

Specifically, when the area of the rough surface portion 11a in the region on the reflection axis side and that in the region on the transmission axis side are represented by Sr and St, respectively, in one embodiment, the following Inequality (2) is satisfied:

$$\frac{S r}{S t} \geq 1 \text{.02} . \qquad ( 2 )$$

Further, in one embodiment, the mirror surface portion 11b is provided in a single region having a diameter of 2 mm or more as a transparent region sufficient as an optical path of illumination light or imaging light in the line-of-sight detection device in the optical element 10 according to the embodiment.

Next, a method for manufacturing the optical element 10 according to the embodiment is described.

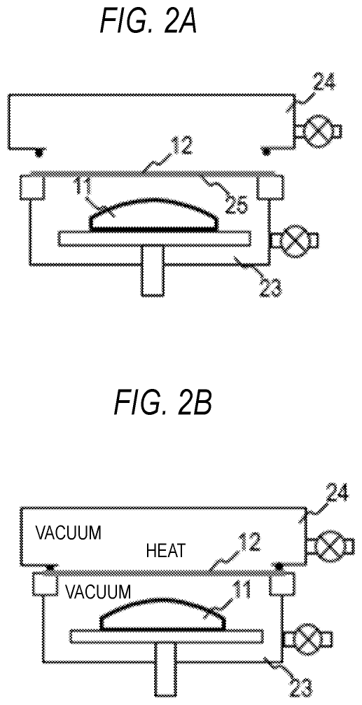

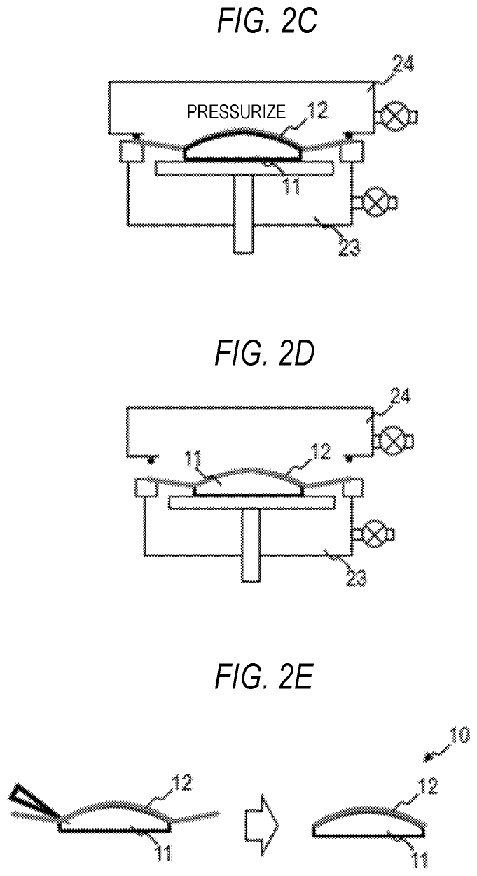

FIGS. 2A, 2B, 2C, 2D and 2E show schematic cross sectional views for explaining respective steps in the method for manufacturing the optical element 10 according to the embodiment.

Hereinafter, a method for manufacturing the optical element 10 according to the embodiment by using vacuum molding is described, but the method for manufacturing the optical element 10 according to the embodiment is not limited thereto, and pressure molding, insert molding or the like may be used.

First, the substrate 11 is arranged in a first chamber 23, and the reflecting polarization film 12 is arranged between the first chamber 23 and a second chamber 24 as shown in FIG. 2A.

At this time, the reflecting polarization film 12 is arranged so as to face the substrate 11, and a uniform adhesive layer 25 is provided on a surface on the substrate 11 side of the reflecting polarization film 12.

Further, a protection film having a glass transition temperature lower than that of the reflecting polarization film 12 may be provided on a surface opposite to the substrate 11 of the reflecting polarization film 12.

By providing such protection film, a strength of the reflecting polarization film 12 is improved, and breakage or the like of the reflecting polarization film 12 can be suppressed when it is attached to the substrate 11.

In addition, the reflecting polarization film 12 is more expensive than a general film, so that the reflecting polarization film 12 may have an area which is 1.5 to 2.5 times an area of the curved surface portion 11c when the curved surface portion 11c of the substrate 11 is projected onto a plane perpendicular to the optical axis, for example, when the reflecting polarization film 12 is arranged as described above.

Further, a supporting film may be attached onto the reflecting polarization film 12. In this case, the glass transition temperature of the support film is to be lower than that of the reflecting polarization film 12 by 0° C. to 20° C. in order to make a deflection of the reflecting polarization film 12 uniform when heated.

Next, the first chamber 23 and the second chamber 24 are evacuated, and the reflecting polarization film 12 is heated in the second chamber 24 as shown in FIG. 2B.

At this time, in general, the reflecting polarization film 12 is directly heated by using an infrared heater, but the whole of the first chamber 23 and the second chamber 24 may be heated by a heater or the like.

On the other hand, when the whole of the first chamber 23 and the second chamber 24 are heated, the substrate 11 is also heated, so that the substrate 11 may be deformed by being heated when the substrate 11 is formed by a plastic material.

Therefore, in one embodiment, a pedestal or the like is formed on which the substrate 11 is placed so as to have a heat insulating structure and to heat the whole of the first chamber 23 and the second chamber 24 such that temperature of the substrate 11 becomes 120° C. or lower.

Next, in one embodiment, only an inside of the second chamber 24 is opened to an atmosphere, and if necessary, a high pressure gas is flowed into the second chamber 24 to increase a pressure thereof after the reflecting polarization film 12 is heated to a predetermined temperature as shown in FIG. 2C.

Thereby, the reflecting polarization film 12 is pressurized to be contacted with the substrate 11. If necessary, the heating and pressurizing of the reflecting polarization film 12 may be continued for a predetermined time.

Next, the heating and pressurizing of the reflecting polarization film 12 are stopped, the second chamber 24 is depressurized to an atmosphere pressure, and then the first chamber 23 is also opened to the atmosphere as shown in FIG. 2D.

Then, an unnecessary portion of the reflecting polarization film 12 other than a portion thereof attached to the curved surface portion 11c of the substrate 11 is cut off as shown in FIG. 2E.

The cutting can be performed by bringing a blade into contact with the curved surface portion 11c along an outer edge thereof or irradiating it with laser light.

In this manner, the optical element 10 according to the embodiment in which the reflecting polarization film 12 is attached to the curved surface portion 11c of the substrate 11 can be manufactured as shown in FIG. 2E.

An appearance of the optical element 10 according to the embodiment manufactured as described above can be evaluated by observing a state of an end portion or the like using an optical microscope such as a digital microscope VHX (manufactured by Keyence Corporation).

Specifically, the optical element 10 can be determined to be a good optical element 10 that satisfies the function and has a satisfactory appearance when no lifting of the reflecting polarization film 12 is observed in a region of the outer peripheral region of the curved surface portion 11c of the substrate 11 in which a width from the outer periphery is equal to or wider than 50 nm.

In addition, the optical element 10 according to the embodiment can also be tested for durability under high temperature and low temperature.

Specifically, the state of the end portion is observed with a microscope after standing for 30 minutes in an environment of 70° C. and that for 30 minutes in an environment of −30° C. are repeated for 30 cycles.

Thereby, it is possible to perform a temperature cycle test for confirming whether a spread of the lifting of the reflecting polarization film 12 or the peeling caused by the lifting occurs.

The curved surface portion 11c of the optical element 10 according to the embodiment shown in FIG. 1A has a circular shape when projected onto a plane perpendicular to the optical axis, but is not limited thereto.

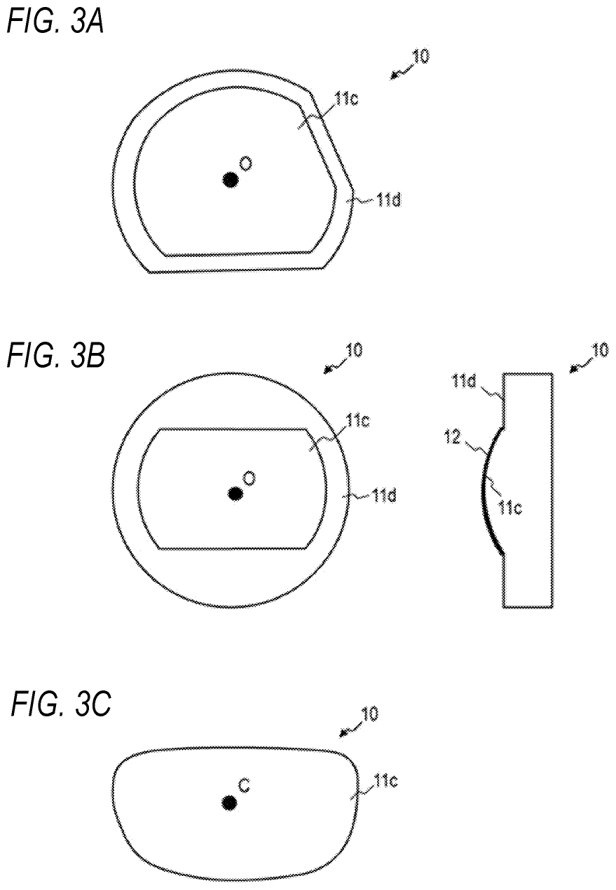

FIGS. 3A, 3B and 3C show schematic front views of the optical elements 10 according to the embodiment each of which has a shape different from a circular shape when the curved surface portion 11c is projected onto the plane perpendicular to the optical axis, respectively.

FIG. 3B also shows a schematic cross sectional view corresponding to the schematic front view of the optical element 10 according to the embodiment shown in FIG. 3B.

In the optical element 10 shown in FIGS. 3A and 3B, a peripheral edge portion 11d is further provided around the optically effective non-circular curved surface portion 11c which determines the outer peripheral region in which the mirror surface portion 11b is provided.

That is, one optical surface may be formed by the curved surface portion 11c and the peripheral edge portion 11d, in other words, the curved surface portion 11c may be provided in a predetermined region of the one optical surface in the optical element 10 shown in FIGS. 3A and 3B.

In each of the optical elements 10 shown in FIGS. 3A and 3B, an outer periphery of the curved surface portion 11c when projected onto the plane perpendicular to the optical axis is formed by two arcs, each of which is a part of a circumference of a common circle, and two line segments.

One of the two line segments is connected to one of pairs of ends of the two circular arcs which are close to each other, and the other of the two line segments is connected to the other of the pairs of ends of the two circular arcs which are close to each other.

A center of the circle common to the two arcs is used as the center O when the curved surface portion 11c in each of the optical elements 10 shown in FIGS. 3A and 3B is projected onto the plane perpendicular to the optical axis.

Then, an outer peripheral region of the curved surface portion 11c in each of the optical elements 10 shown in FIGS. 3A and 3B is defined as a region within a range of 0.9 times to 1.0 times a distance from the center O to the outer periphery in the respective directions in the plane.

On the other hand, the outer periphery of the curved surface portion 11c when projected onto a plane perpendicular to the optical axis is a closed curve having a predetermined shape in the optical element 10 shown in FIG. 3C.

Further, a centroid point of the closed curve is used as a center point C when the curved surface portion 11c of the optical element 10 shown in FIG. 3C is projected onto the plane perpendicular to the optical axis.

The outer peripheral region of the curved surface portion 11c in the optical element 10 shown in FIG. 3C is defined as a region within a range of 0.9 times to 1.0 times a distance from the center point C to the outer periphery in the respective directions in the plane.

The optical element 10 according to the embodiment can be suitably used as a reflecting polarization optical element in a displaying apparatus such as a head-mounted display (HMD), for example.

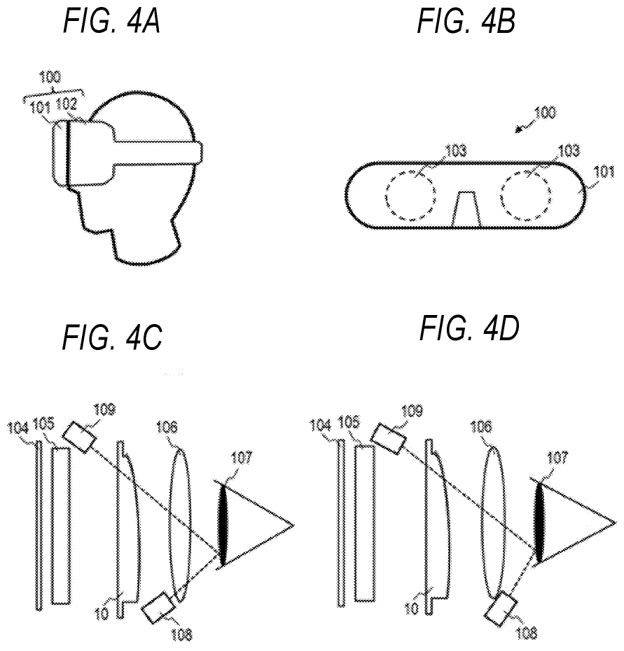

FIGS. 4A and 4B show a schematic side view and a schematic front view of an HMD 100 including the optical element 10 according to the embodiment, respectively.

FIGS. 4C and 4D show partial schematic cross sectional views of the HMD 100 including the optical element 10 according to the embodiment.

As shown in FIGS. 4A and 4B, the HMD 100 includes a housing 101, a mounting fixture 102, and left-eye and right-eye displaying units 103 provided in the housing 101.

The HMD 100 is mounted on a head of a user by the mounting fixture 102 such that the left-eye and right-eye displaying units 103 are positioned corresponding to left and right eyes of the user, respectively.

As shown in FIGS. 4C and 4D, each of the left-eye and right-eye displaying units 103 includes a displaying panel 104 (first displaying unit, second displaying unit), an optical system 105 (first optical system, second optical system), and the optical element 10 according to the embodiment.

The displaying panel 104 is a displaying unit such as an organic electroluminescence (EL) panel or a liquid crystal panel, and is configured to display a corresponding video of videos for the left eye and the right eye.

The optical system 105 is configured to condense video light emitted from the displaying panel 104 such that an image is formed at a position of an eye 107 of the user.

Specifically, the optical system 105 includes at least one of a refractive optical element such as a convex lens or a concave lens, a reflecting optical element such as a concave mirror, and an optical path changing element such as a mirror and a half mirror in accordance with a design of the HMD 100.

As shown in FIGS. 4C and 4D, the optical element 10 according to the embodiment is arranged between the optical system 105 and the eye 107 of the user.

In each of the left-eye and right-eye displaying units 103, a predetermined optical element 106 may be arranged between the optical element 10 according to the embodiment and the eye 107 of the user.

The optical element 10 according to the embodiment forms an optical system that guides the video light emitted from the displaying panel 104 to the eye 107 of the user together with the optical system 105.

Further, each of the left-eye and right-eye displaying units 103 includes an illuminating unit 108 and an image pickup unit 109 which form a line-of-sight detection device as shown in FIGS. 4C and 4D.

The illuminating unit 108 is configured to illuminate the eye 107 of the user, and the image pickup unit 109 is configured to pickup an image of the eye 107 of the user illuminated by the illuminating unit 108.

In the HMD 100, a movement of the eye 107 of the user is detected by the line-of-sight detection device, and the detected movement of the eye 107 of the user is fed back to the displaying panel 104, the optical system 105 or the optical element 10 according to the embodiment.

Thereby, it is possible to reduce a sense of discomfort or fatigue peculiar to the optical system of HMD 100 for the user, and to improve an experience of the user by increasing a resolution of the video in an orientation of the line of sight of the user.

In each of the left-eye and right-eye displaying units 103, light emitted from the illuminating unit 108 or light received by the image pickup unit 109 may pass through the optical element 10 according to the embodiment or a predetermined optical element 106.

For example, the light emitted from the illuminating unit 108 reaches the eye 107 of the user after passing through the predetermined optical element 106 in a case shown in FIG. 4C.

On the other hand, the light emitted from the illuminating unit 108 reaches the eye 107 of the user without passing through the optical element 10 according to the embodiment and the predetermined optical element 106 to directly illuminate the eye 107 of the user in the case shown in FIG. 4D.

In each of the cases shown in FIGS. 4C and 4D, the image pickup unit 109 receives light having passed through the predetermined optical element 106 and the optical element 10 according to the embodiment from the eye 107 of the user.

As described above, the line of sight detection is performed via the optical element 10 according to the embodiment in each of the left-eye and right-eye displaying units 103.

Therefore, the peripheral edge portion 11d provided around the curved surface portion 11c through which the video light emitted from the displaying panel 104 passes can be used as an optical path for the line-of-sight detection device in the optical element 10 according to the embodiment.

In addition, it is possible to suppress occurrence of lifting or peeling of the reflecting polarization film 12 in the rough surface portion 11a, and to use the mirror surface portion 11b as the optical path for the line-of-sight detection device when the optical element 10 is mounted on an HMD 100 in the optical element 10 according to the embodiment.

Next, the optical element 10 according to each of Examples 1, 2, 3, 4, 5, 6 and 7 of the embodiment and an optical element 50 according to a comparative example are described.

### Example 1

The optical element 10 according to Example 1 includes the substrate 11 formed by injection-molding a plastic material containing cycloolefin copolymer (COC) as a main component.

The curved surface portion 11c of the substrate 11 has a convex lens shape having a diameter L of 50 mm, a half opening angle θ of 12°, and a curvature radius R of 114 mm.

Further, the rough surface portion 11a is provided in a region where straight lines each of which forms an angle between −67.5° and 67.5° with respect to a straight line 12b passing through the center O of the curved surface portion 11c and parallel to the reflection axis pass in the outer peripheral region within a range of width of 2 mm from the outer periphery in the curved surface portion 11c.

An arithmetic average roughness Ra of the rough surface portion 11a is 20 nm, and a ratio of an area Sr of the rough surface portion 11a in a region on the reflection axis side to an area St of the rough surface portion 11a in a region on the transmission axis side, namely a value in Inequality (2) is 4.00.

The reflecting polarization film 12 formed by an IQP-E film (3M Corporation) is laminated on the curved surface portion 11c of the substrate 11 in the optical element 10 according to Example 1.

Specifically, the reflecting polarization film 12 has an area of 100 mm×100 mm and a thickness of about 0.07 mm, and an adhesive layer 25 is provided on one surface of the reflecting polarization film 12.

When the optical element 10 according to Example 1 is manufactured, first, the substrate 11 and the reflecting polarization film 12 are arranged as described above with reference to FIG. 2A.

Next, the first chamber 23 and the second chamber 24 are evacuated, and the reflecting polarization film 12 is heated by an infrared heater in the second chamber 24 as shown in FIG. 2B.

Next, in one embodiment, only an inside of the second chamber 24 is opened to an atmosphere after the reflecting polarization film 12 is heated to 150° C. as shown in FIG. 2C.

Then, the reflecting polarization film 12 is pressurized to be contacted with the substrate 11 for 30 seconds by introducing compressed air into the second chamber 24 such that a pressure therein becomes 0.2 MPa.

Next, the heating and pressurizing of the reflecting polarization film 12 are stopped, the second chamber 24 is depressurized to the atmosphere, and then an inside of the first chamber 23 is also opened to the atmosphere as shown in FIG. 2D.

Then, an unnecessary portion of the reflecting polarization film 12 other than a portion thereof attached to the curved surface portion 11c of the substrate 11 are cut off to manufacture the optical element 10 according to Example 1 in which the reflecting polarization film 12 is attached to the curved surface portion 11c of the substrate 11 as shown in FIG. 2E.

As a result of evaluating an appearance of each of the optical elements 10 according to Example 1 after the manufacture and that after a temperature cycle test, neither lifting nor peeling of the reflecting polarization film 12 has been observed at positions of 40 μm or more from an outer edge portion.

Further, as a result of mounting the optical element 10 according to Example 1 on each of left-eye and right-eye displaying units 103 in the HMD 100, it has been possible to favorably project a video onto the eye 107 of a user and to favorably detect the line of sight of the user.

The above-described specification values of the optical element 10 according to Example 1 are shown in the following Table 1.

Further, Table 1 shows an evaluation of the optical element 10 of each Example. Specifically, the evaluation is based on a condition that occurrence of lifting or peeling is allowed in a range of 50 μm or less from the outer edge portion, and a determination as to whether a line-of-sight measurement is possible when the optical element 10 is mounted on each of the left-eye and right-eye displaying units 103 in the HMD 100.

Specifically, the optical element 10 in which neither lifting nor peeling of the reflecting polarization film 12 is observed at positions of 25 μm or more from the outer edge portion and the line of sight can be measured when mounted on each of the left-eye and right-eye displaying units 103 in the HMD 100 is evaluated as Evaluation A.

On the other hand, the optical element 10 in which neither lifting nor peeling of the reflecting polarization film 12 is observed at positions 50 μm or more from the outer edge portion and the line of sight can be measured when mounted on each of the left-eye and right-eye displaying units 103 in the HMD 100 is evaluated as Evaluation B.

Further, the optical element 10 in which lifting or peeling of the reflecting polarization film 12 is observed at positions of 50 μm or more from the outer edge portion and/or the line of sight cannot be measured when mounted on each of the left-eye and right-eye displaying units 103 in the HMD 100 is evaluated as Evaluation C.

That is, the optical element 10 according to Example 1 is evaluated as Evaluation B from the above-described results.

### Example 2

The optical element 10 according to Example 2 includes the substrate 11 formed by injection-molding a plastic material containing cycloolefin copolymer (COC) as a main component.

The curved surface portion 11c of the substrate 11 has a convex lens shape having a diameter L of 50 mm, a half opening angle θ of 12°, and a curvature radius R of 114 mm.

Further, the rough surface portion 11a is provided in a region where straight lines each of which forms an angle between −67.5° and 67.5° with respect to a straight line 12b passing through the center O of the curved surface portion 11c and parallel to the reflection axis pass in the outer peripheral region within a range of width of 1 mm from the outer periphery in the curved surface portion 11c.

An arithmetic average roughness Ra of the rough surface portion 11a is 20 nm, and a ratio of an area Sr of the rough surface portion 11a in a region on the reflection axis side to an area St of the rough surface portion 11a in a region on the transmission axis side, namely a value in Inequality (2) is 4.00.

The reflecting polarization film 12 formed by an IQP-E film (3M Corporation) is laminated on the curved surface portion 11c of the substrate 11 in the optical element 10 according to Example 2.

Specifically, the reflecting polarization film 12 has an area of 100 mm×100 mm and a thickness of about 0.07 mm, and an adhesive layer 25 is provided on one surface of the reflecting polarization film 12.

The optical element 10 according to Example 2 is manufactured by the same method as the optical element 10 according to Example 1 described above.

As a result of evaluating the appearance of each of the optical elements 10 according to Example 2 after the manufacturing and after the temperature cycle test, neither lifting nor peeling of the reflecting polarization film 12 has been confirmed at a position of 45 μm or more from the outer periphery.

In addition, as a result of mounting the optical element 10 according to Example 2 on each of the left-eye and right-eye displaying units 103 in the HMD 100, it has been possible to favorably project a video onto the eye 107 of the user and to favorably detect the line of sight of the user.

The above-described specification values of the optical element 10 according to Example 2 are shown in the following Table 1.

The optical element 10 according to Example 2 is evaluated as Evaluation B from the above-described results.

### Example 3

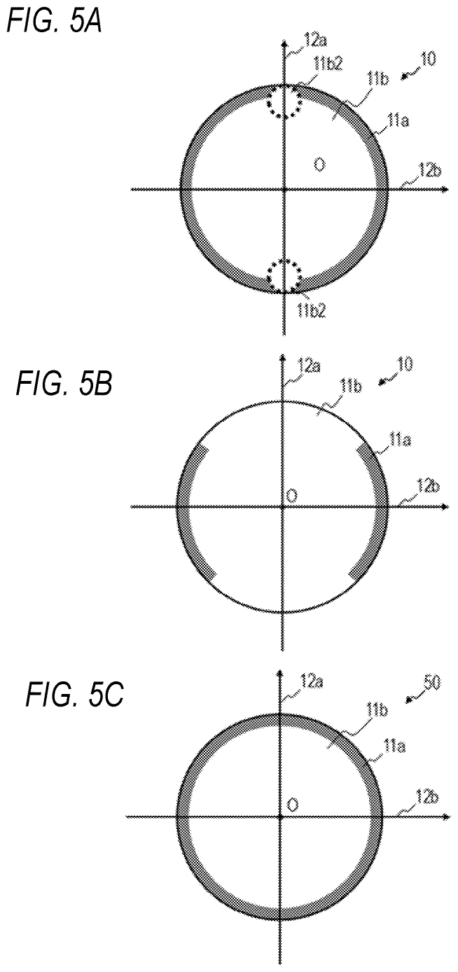

FIG. 5A shows a schematic front view of the optical element 10 according to Example 3.

The optical element 10 according to Example 3 includes the substrate 11 formed by injection-molding a plastic material containing cycloolefin copolymer (COC) as a main component.

The curved surface portion 11c of the substrate 11 has a concave lens shape having a diameter L of 50 mm, a half opening angle θ of 12°, and a curvature radius R of 114 mm.

Further, as shown in FIG. 5A, two mirror surface portions 11b2 are provided on the opposite sides with respect to the straight line 12b when the curved surface portion 11c is projected onto a plane perpendicular to the optical axis in the curved surface portion 11c.

Specifically, each of the two mirror surface portions 11b2 (first region and second region) has a circular shape whose center is located on the straight line 12a, which has a diameter of 2 mm, and which is inscribed in the outer periphery of the curved surface portion 11c when the curved surface portion 11c is projected onto the plane perpendicular to the optical axis.

On the other hand, the rough surface portion 11a is provided in the entire region other than the region included in the two mirror surface portions 11b2 in the outer peripheral region within a range of width of 2 mm from the outer periphery when the curved surface portion 11c is projected onto the plane perpendicular to the optical axis.

Then, the mirror surface portion 11b is provided in a region other than the two mirror surface portions 11b2 and the rough surface portion 11a in the curved surface portion 11c.

An arithmetic average roughness Ra of the rough surface portion 11a is 20 nm, and a ratio of an area Sr of the rough surface portion 11a in a region on the reflection axis side to an area St of the rough surface portion 11a in a region on the transmission axis side, namely a value in Inequality (2) is 1.04.

The reflecting polarization film 12 formed by an IQP-E film (3M Corporation) is laminated on the curved surface portion 11c of the substrate 11 in the optical element 10 according to Example 3.

Specifically, the reflecting polarization film 12 has an area of 100 mm×100 mm and a thickness of about 0.07 mm, and an adhesive layer 25 is provided on one surface of the reflecting polarization film 12.

The optical element 10 according to Example 3 is manufactured by the same method as the optical element 10 according to Example 1 described above.

As a result of evaluating the appearance of each of the optical elements 10 according to Example 3 after the manufacturing and after the temperature cycle test, neither lifting nor peeling of the reflecting polarization film 12 has been confirmed at a position of 20 μm or more from the outer periphery.

In addition, as a result of mounting the optical element 10 according to Example 3 on each of the left-eye and right-eye displaying units 103 in the HMD 100, it has been possible to favorably project a video onto the eye 107 of the user and to favorably detect the line of sight of the user.

The above-described specification values of the optical element 10 according to Example 3 are shown in the following Table 1.

The optical element 10 according to Example 3 is evaluated as Evaluation A from the above-described results.

### Example 4

The optical element 10 according to Example 4 includes the substrate 11 formed by injection-molding a plastic material containing cycloolefin copolymer (COC) as a main component.

The curved surface portion 11c of the substrate 11 has a concave lens shape having a diameter L of 50 mm, a half opening angle θ of 12°, and a curvature radius R of 114 mm.

In the curved surface portion 11c of the optical element 10 according to Example 4, a single mirror surface portion 11b2 is provided on one side with respect to the straight line 12b when the curved surface portion 11c is projected onto a plane perpendicular to the optical axis.

Specifically, the single mirror surface portion 11b2 has a circular shape whose center is located on the straight line 12a, which has a diameter of 2 mm, and which is inscribed in the outer periphery of the curved surface portion 11c when the curved surface portion 11c is projected onto the plane perpendicular to the optical axis.

On the other hand, the rough surface portion 11a is provided in the entire region other than the region included in the single mirror surface portion 11b2 in the outer peripheral region within a range of width of 2 mm from the outer periphery when the curved surface portion 11c is projected onto the plane perpendicular to the optical axis.

Then, the mirror surface portion 11b is provided in a region other than the single mirror surface portion 11b2 and the rough surface portion 11a in the curved surface portion 11c.

An arithmetic average roughness Ra of the rough surface portion 11a is 20 nm, and a ratio of an area Sr of the rough surface portion 11a in a region on the reflection axis side to an area St of the rough surface portion 11a in a region on the transmission axis side, namely a value in Inequality (2) is 1.02.

The reflecting polarization film 12 formed by an IQP-E film (3M Corporation) is laminated on the curved surface portion 11c of the substrate 11 in the optical element 10 according to Example 4.

Specifically, the reflecting polarization film 12 has an area of 100 mm×100 mm and a thickness of about 0.07 mm, and an adhesive layer 25 is provided on one surface of the reflecting polarization film 12.

The optical element 10 according to Example 4 is manufactured by the same method as the optical element 10 according to Example 1 described above.

As a result of evaluating the appearance of each of the optical elements 10 according to Example 4 after the manufacturing and after the temperature cycle test, neither lifting nor peeling of the reflecting polarization film 12 has been confirmed at a position of 20 μm or more from the outer periphery.

In addition, as a result of mounting the optical element 10 according to Example 4 on each of the left-eye and right-eye displaying units 103 in the HMD 100, it has been possible to favorably project a video onto the eye 107 of the user and to favorably detect the line of sight of the user.

The above-described specification values of the optical element 10 according to Example 4 are shown in the following Table 1.

The optical element 10 according to Example 4 is evaluated as Evaluation A from the above-described results.

### Example 5

The optical element 10 according to Example 5 includes the substrate 11 formed by injection-molding a plastic material containing cycloolefin copolymer (COC) as a main component.

The curved surface portion 11c of the substrate 11 has a concave lens shape having a diameter L of 50 mm, a half opening angle θ of 12°, and a curvature radius R of 114 mm.

Further, as shown in FIG. 5A, two mirror surface portions 11b2 are provided on the opposite sides with respect to the straight line 12b when the curved surface portion 11c is projected onto a plane perpendicular to the optical axis in the curved surface portion 11c.

Specifically, each of the two mirror surface portions 11b2 has a circular shape whose center is located on the straight line 12a, which has a diameter of 2 mm, and which is inscribed in the outer periphery of the curved surface portion 11c when the curved surface portion 11c is projected onto the plane perpendicular to the optical axis.

On the other hand, the rough surface portion 11a is provided in the entire region other than the region included in the two mirror surface portions 11b2 in the outer peripheral region within a range of width of 0.5 mm from the outer periphery when the curved surface portion 11c is projected onto the plane perpendicular to the optical axis.

Then, the mirror surface portion 11b is provided in a region other than the two mirror surface portions 11b2 and the rough surface portion 11a in the curved surface portion 11c.

An arithmetic average roughness Ra of the rough surface portion 11a is 20 nm, and a ratio of an area Sr of the rough surface portion 11a in a region on the reflection axis side to an area St of the rough surface portion 11a in a region on the transmission axis side, namely a value in Inequality (2) is 1.06.

The reflecting polarization film 12 formed by an IQP-E film (3M Corporation) is laminated on the curved surface portion 11c of the substrate 11 in the optical element 10 according to Example 5.

Specifically, the reflecting polarization film 12 has an area of 100 mm×100 mm and a thickness of about 0.07 mm, and an adhesive layer 25 is provided on one surface of the reflecting polarization film 12.

The optical element 10 according to Example 5 is manufactured by the same method as the optical element 10 according to Example 1 described above.

As a result of evaluating the appearance of each of the optical elements 10 according to Example 5 after the manufacturing and after the temperature cycle test, neither lifting nor peeling of the reflecting polarization film 12 has been confirmed at a position of 45 μm or more from the outer periphery.

In addition, as a result of mounting the optical element 10 according to Example 5 on each of the left-eye and right-eye displaying units 103 in the HMD 100, it has been possible to favorably project a video onto the eye 107 of the user and to favorably detect the line of sight of the user.

The above-described specification values of the optical element 10 according to Example 5 are shown in the following Table 1.

The optical element 10 according to Example 5 is evaluated as Evaluation B from the above-described results.

### Example 6

The optical element 10 according to Example 6 includes the substrate 11 formed by injection-molding a plastic material containing cycloolefin copolymer (COC) as a main component.

The curved surface portion 11c of the substrate 11 has a concave lens shape having a diameter L of 50 mm, a half opening angle θ of 12°, and a curvature radius R of 114 mm.

In the curved surface portion 11c of the optical element 10 according to Example 6, a single mirror surface portion 11b2 is provided on one side with respect to the straight line 12b when the curved surface portion 11c is projected onto a plane perpendicular to the optical axis.

Specifically, the single mirror surface portion 11b2 has a circular shape whose center is located on the straight line 12a, which has a diameter of 2 mm, and which is inscribed in the outer periphery of the curved surface portion 11c when the curved surface portion 11c is projected onto the plane perpendicular to the optical axis.

On the other hand, the rough surface portion 11a is provided in the entire region other than the region included in the single mirror surface portion 11b2 in the outer peripheral region within a range of width of 0.5 mm from the outer periphery when the curved surface portion 11c is projected onto the plane perpendicular to the optical axis.

Then, the mirror surface portion 11b is provided in a region other than the single mirror surface portion 11b2 and the rough surface portion 11a in the curved surface portion 11c.

An arithmetic average roughness Ra of the rough surface portion 11a is 40 nm, and a ratio of an area Sr of the rough surface portion 11a in a region on the reflection axis side to an area St of the rough surface portion 11a in a region on the transmission axis side, namely a value in Inequality (2) is 1.03.

The reflecting polarization film 12 formed by an IQP-E film (3M Corporation) is laminated on the curved surface portion 11c of the substrate 11 in the optical element 10 according to Example 6.

Specifically, the reflecting polarization film 12 has an area of 100 mm×100 mm and a thickness of about 0.07 mm, and an adhesive layer 25 is provided on one surface of the reflecting polarization film 12.

The optical element 10 according to Example 6 is manufactured by the same method as the optical element 10 according to Example 1 described above.

As a result of evaluating the appearance of each of the optical elements 10 according to Example 6 after the manufacturing and after the temperature cycle test, neither lifting nor peeling of the reflecting polarization film 12 has been confirmed at a position of 45 μm or more from the outer periphery.

In addition, as a result of mounting the optical element 10 according to Example 6 on each of the left-eye and right-eye displaying units 103 in the HMD 100, it has been possible to favorably project a video onto the eye 107 of the user and to favorably detect the line of sight of the user.

The above-described specification values of the optical element 10 according to Example 6 are shown in the following Table 1.

The optical element 10 according to Example 6 is evaluated as Evaluation B from the above-described results.

### Example 7

FIG. 5B shows a schematic front view of the optical element 10 according to Example 7.

The optical element 10 according to Example 7 includes the substrate 11 formed by injection-molding a plastic material containing cycloolefin copolymer (COC) as a main component.

The curved surface portion 11c of the substrate 11 has a concave lens shape having a diameter L of 50 mm, a half opening angle θ of 23°, and a curvature radius R of 65 mm.

Further, the rough surface portion 11a is provided in a region where straight lines each of which forms an angle between −45° and 45° with respect to a straight line 12b passing through the center O of the curved surface portion 11c and parallel to the reflection axis pass in the outer peripheral region within a range of width of 2 mm from the outer periphery in the curved surface portion 11c.

That is, the rough surface portion 11a is not provided in a region on the transmission axis side, and an area of the rough surface portion 11a in the region on the transmission axis side is zero, in other words, an expression of St=0 is satisfied in the optical element 10 according to Example 7.

Then, the mirror surface portion 11b is provided in a region other than the rough surface portion 11a in the curved surface portion 11c.

An arithmetic average roughness Ra of the rough surface portion 11a is 40 nm, and a ratio of an area Sr of the rough surface portion 11a in a region on the reflection axis side to the area St of the rough surface portion 11a in the region on the transmission axis side, namely a value in Inequality (2) is infinite.

The reflecting polarization film 12 formed by an IQP-E film (3M Corporation) is laminated on the curved surface portion 11c of the substrate 11 in the optical element 10 according to Example 7.

Specifically, the reflecting polarization film 12 has an area of 100 mm×100 mm and a thickness of about 0.07 mm, and an adhesive layer 25 is provided on one surface of the reflecting polarization film 12.

The optical element 10 according to Example 7 is manufactured by the same method as the optical element 10 according to Example 1 described above.

As a result of evaluating the appearance of each of the optical elements 10 according to Example 7 after the manufacturing and after the temperature cycle test, neither lifting nor peeling of the reflecting polarization film 12 has been confirmed at a position of 48 μm or more from the outer periphery.

In addition, as a result of mounting the optical element 10 according to Example 7 on each of the left-eye and right-eye displaying units 103 in the HMD 100, it has been possible to favorably project a video onto the eye 107 of the user and to favorably detect the line of sight of the user.

The above-described specification values of the optical element 10 according to Example 7 are shown in the following Table 1.

The optical element 10 according to Example 7 is evaluated as Evaluation B from the above-described results.

### COMPARATIVE EXAMPLE

FIG. 5C shows a schematic front view of an optical element 50 according to a comparative example.

The optical element 50 according to the comparative example includes the substrate 11 formed by injection-molding a plastic material containing cycloolefin copolymer (COC) as a main component.

The curved surface portion 11c of the substrate 11 has a convex lens shape having a diameter L of 50 mm, a half opening angle θ of 12°, and a curvature radius R of 114 mm.

In addition, the rough surface portion 11a is provided in the entire outer peripheral region within a range of width of 2 mm from the outer periphery in the curved surface portion 11c.

Then, the mirror surface portion 11b is provided in a region other than the rough surface portion 11a in the curved surface portion 11c.

An arithmetic average roughness Ra of the rough surface portion 11a is 50 nm, and a ratio of an area Sr of the rough surface portion 11a in a region on the reflection axis side to the area St of the rough surface portion 11a in the region on the transmission axis side, namely a value in Inequality (2) is 1.00.

The reflecting polarization film 12 formed by an IQP-E film (3M Corporation) is laminated on the curved surface portion 11c of the substrate 11 in the optical element 50 according to the comparative example.

Specifically, the reflecting polarization film 12 has an area of 100 mm×100 mm and a thickness of about 0.07 mm, and an adhesive layer 25 is provided on one surface of the reflecting polarization film 12.

The optical element 50 according to the comparative example is manufactured by the same method as the optical element 10 according to Example 1 described above.

As a result of evaluating the appearance of each of the optical elements 50 according to the comparative example after the manufacturing and after the temperature cycle test, neither lifting nor peeling of the reflecting polarization film 12 has been confirmed at a position of 20 μm or more from the outer periphery.

On the other hand, as a result of mounting the optical element 50 according to the comparative example on each of the left-eye and right-eye displaying units 103 in the HMD 100, the line of sight of the eye 107 of the user has not been able to be detected.

This is because the rough surface portion 11a is provided over the entire outer peripheral region in the curved surface portion 11c in the optical element 50 according to the comparative example.

The above-described specification values of the optical element 50 according to the comparative example are shown in the following Table 1.

The optical element 50 according to the comparative example is evaluated as Evaluation C from the above-described results.

The following Table 1 shows the specification values of the optical elements 10 according to Examples 1 to 7 and the optical element 50 according to Comparative example.

TABLE 1

| | | Existence of rough | Arithmetic | | |
|---|---|---|---|---|---|
| | | surface portion 11a | average | | |
| | Shape of | in a region on a | roughness Ra of | Curvature radius R | |
| | curved | transmission axis | rough surface | of curved surface | |
| | surface | side | portion 11a [nm] | portion 11c [mm] | |
| Ex. 1 | Convex | Existence | 20 | 114 | |
| Ex. 2 | Convex | Existence | 20 | 114 | |
| Ex. 3 | Concave | Existence | 20 | 114 | |
| Ex. 4 | Concave | Existence | 20 | 114 | |
| Ex. 5 | Concave | Existence | 20 | 114 | |
| Ex. 6 | Concave | Existence | 40 | 114 | |
| Ex. 7 | Concave | Non-existence | 40 | 65 | |
| Com. | Convex | Existence | 50 | 114 | |
| Ex. | | | | | |
| | | | | Width from outer | |
| | Half opening | | | periphery in which | |
| | angle θ of | | | lifting or peeling | |
| | curved surface | | Line-of-sight | has been confirmed | |
| | portion 11c [°] | Area ratio Sr/St | detection | [μm] | Evaluation |
| Ex. 1 | 12 | 4.00 | Able | 40 | B |
| Ex. 2 | 12 | 4.00 | Able | 45 | B |
| Ex. 3 | 12 | 1.04 | Able | 20 | A |
| Ex. 4 | 12 | 1.02 | Able | 20 | A |
| Ex. 5 | 12 | 1.06 | Able | 45 | B |
| Ex. 6 | 12 | 1.03 | Able | 45 | B |
| Ex. 7 | 23 | Infinity | Able | 48 | B |
| Com. | 12 | 1.00 | Unable | 20 | C |
| Ex. | | | | | |

According to the embodiment, an optically transparent region for detecting the line of sight can be provided with suppressing adhesion failure of the reflecting polarization film 12 in the peripheral portion in the optical element 10 to which the reflecting polarization film 12 manufactured by uniaxial stretching is attached.

Although exemplary embodiments have been described above, the disclosure is not limited to these embodiments, and various modifications and changes can be made within the scope of the gist of the disclosure.

For example, although the optical element 10 in which the reflecting polarization film 12 is attached on the substrate 11 has been described above, the above-described structure can also be applied to an optical element on which a polarization film or a film having other optical characteristics is attached.

That is, according to the disclosure, it is possible to provide an optical element capable of achieving both of suppression of adhesion failure of a film to a substrate and guiding of desired light.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-070150, filed Apr. 22, 2025, which is hereby incorporated by reference herein in its entirety.

What is claimed is:

1. An optical element, comprising:
a substrate having an optical surface including a predetermined region in a curved surface shape; and
a film provided on the predetermined region,
wherein a rough surface portion having a first surface roughness, and a mirror surface portion having a second surface roughness smaller than the first surface roughness are provided in an outer peripheral region in the predetermined region.

2. The optical element according to claim 1, wherein the film includes a reflecting polarization film.

3. The optical element according to claim 2, wherein the mirror surface portion includes a first region provided so as to be closer to a second straight line including a center of the predetermined region and parallel to a transmission axis of the reflecting polarization film than to a first straight line including the center of the predetermined region and parallel to a reflection axis of the reflecting polarization film when projected onto a first plane perpendicular to an optical axis of the optical element.

4. The optical element according to claim 3, wherein the mirror surface portion includes the first region and a second region each of which has a circular shape whose center is located on the second straight line and which is inscribed in an outer periphery of the predetermined region on opposite sides with respect to the first straight line when projected onto the first plane.

5. The optical element according to claim 2, wherein a first area of the rough surface portion included in a third region is larger than a second area of the rough surface portion included in a fourth region other than the third region, the third region being closer to a first straight line including a center of the predetermined region and parallel to a reflection axis of the reflecting polarization film than to a second straight line including the center of the predetermined region and parallel to a transmission axis of the reflecting polarization film, among the outer peripheral region when projected onto a first plane perpendicular to an optical axis of the optical element.

6. The optical element according to claim 5, wherein the following inequality is satisfied:
$$\frac{Sr}{St} \geq 1.02$$
where Sr represents the first area, and St represents the second area.

7. The optical element of claim 5, wherein the second area is zero.

8. The optical element according to claim 1, wherein the mirror surface portion includes a first region having a diameter equal to or larger than 2 mm when projected onto a first plane perpendicular to an optical axis of the optical element.

9. The optical element according to claim 1, wherein an arithmetic average roughness of the rough surface portion is equal to or larger than 20 nm.

10. A displaying apparatus, comprising:
a first displaying unit; and
a first optical system which includes the optical element according to claim 1 and is configured to guide light from the first displaying unit.

11. The displaying apparatus according to claim 10, further comprising:
a second displaying unit; and
a second optical system including the optical element of the first optical system, the second optical system being configured to guide light from the second displaying unit to a right eye of a user,
wherein the first optical system is configured to guide the light from the first displaying unit to a left eye of the user.

12. The displaying apparatus according to claim 10, wherein the film of the optical element includes a reflecting polarization film.

13. The displaying apparatus according to claim 12, wherein the mirror surface portion of the optical element includes a first region provided so as to be closer to a second straight line including a center of the predetermined region and parallel to a transmission axis of the reflecting polarization film than to a first straight line including the center of the predetermined region and parallel to a reflection axis of the reflecting polarization film when projected onto a first plane perpendicular to an optical axis of the optical element.

14. The displaying apparatus according to claim 10, wherein the mirror surface portion of the optical element includes a first region having a diameter equal to or larger than 2 mm when projected onto a first plane perpendicular to an optical axis of the optical element.

15. The displaying apparatus according to claim 10, wherein, in the optical element, an arithmetic average roughness of the rough surface portion is equal to or larger than 20 nm.

16. The displaying apparatus according to claim 11, further comprising:
an illuminating unit configured to illuminate one of the left eye and the right eye of the user; and
an image pickup unit configured to pickup an image of the one of the left eye and the right eye of the user illuminated by the illuminating unit,
wherein at least a part of light incident on the image pickup unit from the one of the left eye and the right eye of the user passes through the mirror surface portion of the optical element included in corresponding one of the first optical system and the second optical system.

17. The displaying apparatus according to claim 16, wherein the film of the optical element includes a reflecting polarization film.

18. The displaying apparatus according to claim 17, wherein the mirror surface portion of the optical element includes a first region provided so as to be closer to a second straight line including a center of the predetermined region and parallel to a transmission axis of the reflecting polarization film than to a first straight line including the center of the predetermined region and parallel to a reflection axis of the reflecting polarization film when projected onto a first plane perpendicular to an optical axis of the optical element.

19. The displaying apparatus according to claim 16, wherein the mirror surface portion of the optical element includes a first region having a diameter equal to or larger than 2 mm when projected onto a first plane perpendicular to an optical axis of the optical element.

20. The displaying apparatus according to claim 16, wherein, in the optical element, an arithmetic average roughness of the rough surface portion is equal to or larger than 20 nm.
